(19) United States
(12) Patent Application Publication
(10) Pub. No.: US 2014/0138102 A1
(43) Pub. Date: May 22, 2014

(54) EFFERVESCENT FIRE SUPPRESSION

(71) Applicants: May L. Corn, Manchester, CT (US); Michael R. Carey, East Hampton, CT (US); Jeffrey M. Cohen, Hebron, CT (US); Bryan Robert Siewert, Clinton, CT (US); Thierry Carriere, Littleton, CO (US); Joshua A. Sheffel, Manchester, CT (US)

(72) Inventors: May L. Corn, Manchester, CT (US); Michael R. Carey, East Hampton, CT (US); Jeffrey M. Cohen, Hebron, CT (US); Bryan Robert Siewert, Clinton, CT (US); Thierry Carriere, Littleton, CO (US); Joshua A. Sheffel, Manchester, CT (US)

(21) Appl. No.: 14/128,157

(22) PCT Filed: Jun. 22, 2011
(86) PCT No.: PCT/US2011/041354

§ 371 Date: Dec. 20, 2013

(51) Int. Cl. A62C 35/68

(52) U.S. Cl. CPC A62C 35/68
USPC 169/14

(57) ABSTRACT

An exemplary fire suppression system includes a nozzle body configured to carry a fire suppressing fluid to be discharged from a first orifice array and a second orifice array. Gas bubbles can be introduced through a bubbler into the fire suppressing fluid to establish a bubbly mixture in the nozzle. Each first orifice in the first orifice array has a first flow property and is configured to receive the bubbly mixture and through effervescent atomization yield a first fire suppression mist from the first orifice array. Each second orifice in the second orifice array has a second different flow property and is configured to receive the bubbly mixture and through effervescent atomization yield a second fire suppression mist from the second orifice array. The first fire suppression mist and the second fire suppression mist are configured to provide a selected fire suppression nozzle discharge.

### BACKGROUND

Fire suppression systems are useful for extinguishing or containing a fire within a building. There are a variety of known fire suppression systems that include a plurality of sprinkler heads or nozzles near the ceiling in a room where fire protection is desired. Traditional sprinkler systems disperse relatively large amounts of water into the room responsive to fire conditions. Other systems are known as mist systems because they disperse a mist of water into an area, typically an enclosed area, responsive to fire conditions.

Mist systems have certain advantages in that they typically utilize less water. One challenge associated with known mist systems is they require operating at relatively high pressure. Maintaining adequate high pressure within the system typically requires a dedicated pressure source and water conduits that are capable of withstanding the pressure of the system. Additionally, nozzle design has to accommodate the relatively high pressures.

### SUMMARY

An exemplary fire suppression system includes a nozzle body configured to carry a fire suppressing fluid to be discharged from a first orifice array and a second orifice array. Gas bubbles can be introduced through a bubbler into the fire suppressing fluid to establish a bubbly mixture in the nozzle. The first orifice array includes at least one first orifice, each first orifice in the first orifice array has a first flow property and is configured to receive the bubbly mixture and through effervescent atomization yield a first fire suppression mist from the first orifice array. The second orifice array includes at least one second orifice, each second orifice in the second orifice array has a second different flow property and is configured to receive the bubbly mixture and through effervescent atomization yield a second fire suppression mist from the second orifice array. The first fire suppression mist and the second fire suppression mist are configured to provide a selected fire suppression nozzle discharge.

The various features and advantages of disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example fire suppression system including nozzles designed according to an embodiment of this invention.

FIG. 2 schematically illustrates a feature of an example nozzle during fire suppression.

FIG. 3 diagrammatically illustrates an example nozzle configuration designed according to an embodiment of this invention.

FIG. 4 diagrammatically illustrates another nozzle configuration designed according to an embodiment of this invention.

FIG. 5 illustrates another example nozzle configuration designed according to an embodiment of this invention.

FIG. 6 illustrates another example nozzle configuration designed according to an embodiment of this invention.

FIGS. 7A and 7B illustrate another nozzle configuration designed according to an embodiment of this invention.

FIGS. 8A and 8B illustrate another nozzle configuration designed according to an embodiment of this invention.

### DETAILED DESCRIPTION

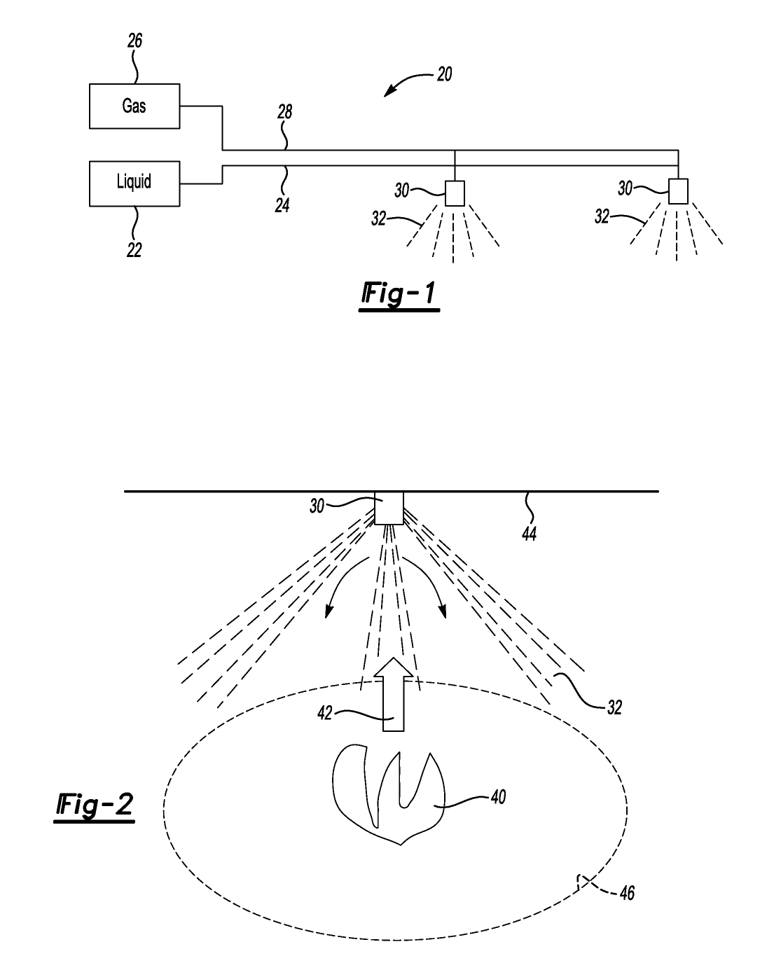

FIG. 1 schematically shows selected portions of an example fire suppression system 20. A source of fire suppressing liquid 22 is coupled with supply lines 24 to provide the fire suppressing liquid within the system 20. In one example, the fire suppressing liquid comprises water.

A gas source 26 is connected with supply lines 28 for supplying gas within the system 20. Example gases useful in some embodiments include air, nitrogen and carbon dioxide. In this example, the supply lines 24 and 28 are each connected with a plurality of nozzles 30 for supplying liquid from the liquid source 22 and gas from the gas source 26 to each of the nozzles 30.

The example system 20 operates at a relatively low pressure and uses effervescent atomization to provide a fire suppression discharge 32 from the nozzles 30 for suppressing or extinguishing a fire within an area protected by the system 20. Effervescent atomization in this discussion refers to the process by which bubbles in a bubbly fluid mixture expand sufficiently to shatter the liquid of the fluid mixture into droplets. The effervescent atomization of the discussed examples typically occurs when the bubbles experience a pressure drop as they enter ambient conditions upon exiting the nozzles 30. The resulting mist, spray or discharge from the nozzles 30 is referred to as a fire suppression discharge or fire suppression nozzle discharge for purposes of discussion.

Referring to FIG. 2, a fire 40 has buoyant forces schematically shown at 42. In an open space application (e.g., a large room or building), such buoyant forces 42 may prevent some mists from providing a desired fire suppressing or extinguishing affect. With the disclosed examples, the fire suppression discharge 32 has, among other things, sufficient penetration to overcome the buoyant forces 42. The fire suppression discharge 32 provided by the illustrated examples provide, among other things, sufficient penetration to be effective as a fire suppression discharge.

In the example of FIG. 2, the fire suppression discharge 32 covers a generally circular area 46 beneath the nozzle 30. In one example, the circular area 46 has a radius of approximately 3.5 meters at a distance 5 meters below the nozzle 30. Some examples provide a spray having a circumferential uniformity sufficient to ensure that the average water flux measured in any 0.25 square meter area in the range of coverage of a nozzle 30 is greater than 0.05 liters per minute per square meter. In one such example, the average water flux measured inside the circle 46 with a one meter radius located 5 meters directly below the nozzle 30 is at least one liter per minute per square meter. Example installations for the example nozzles 30 will provide a distribution of fire suppressing fluid at a distance between about 1 meter and about 5 meters below the nozzle body.

Mist suppresses fire through a variety of mechanisms including, evaporative cooling, inerting, radiation blocking, and wetting. The combination of droplet size and velocity creates the spray momentum, and are factors enabling water mist to, among other things, both disperse and also penetrate a fire in a select fire suppression discharge from a nozzle. One way to effectively achieve all of these effects utilizing effervescent atomization is to provide a nozzle with a first orifice array in which each orifice has a first flow property and a second orifice array in which each orifice has a second different flow property.

According to the present invention, a nozzle body is configured to carry a fire suppressing fluid to be discharged from a first orifice array, and a second orifice array. The nozzle includes a bubbler through which gas bubbles can be introduced into the fire suppressing fluid to establish a bubbly mixture in the nozzle. Each orifice in the first orifice array has a first flow property and is configured to receive the bubbly mixture and through effervescent atomization yield a first fire suppression mist from the first orifice array. Each orifice in the second orifice array has a second different flow property and is configured to receive the bubbly mixture and through effervescent atomization yield a second fire suppression mist from the second orifice array. The first fire suppression mist and the second fire suppression mist are configured to provide a selected fire suppression nozzle discharge. In one embodiment, a nozzle 30 includes a nozzle body 50 having at least one of the first orifice array and the second orifice array including a plurality of orifices. In one embodiment, nozzle 30 includes a nozzle body 50 having a plurality of first nozzle orifices 52 and a plurality of second nozzle orifices 54. Providing two different flow properties allows for achieving a desired fire suppression discharge from the nozzle 30.

Various nozzle configurations are presented that provide different ways of realizing the different flow properties. One way of achieving different flow properties includes providing the first orifices 52 with a different cross-sectional dimension than that of the second orifices 54. The relevant cross-sectional dimension in this example is perpendicular to a direction of flow through the orifice. A direction of flow is aligned with a central axis through the orifice and schematically shown at 52a for the first orifices 52. The relevant cross-sectional dimension for achieving the desired flow property for the first orifices 52 is the cross-sectional dimension perpendicular to the line 52a.

In one embodiment, the first orifices 52 have a circular, cross-sectional profile along the length of the orifices as they extend through the nozzle body 50. At the exit point of the first orifices 52 along an outer surface 56 of the nozzle body 50, the first orifices 52 have a generally oval or elliptical profile. Similarly, a generally oval or elliptical profile can be seen at the inlet to each first orifice 52 where the first orifices 52 interrupt an interior surface 58 of the nozzle body 50. In this example, the diameter or radius of the circular cross-sectional dimension is the one that is relevant for determining whether the first orifices 52 have a desired flow property. The dimensions of the oval or elliptical profiles on the surfaces 58 and 56 (i.e., at the inlet and outlet of the orifices) are less important in this example. In other words, the dimension of a tool used for boring a hole through the nozzle body 50 to establish the first orifices 52 establishes the cross-sectional dimension that is used for establishing the desired flow property of the example first orifices 52.

The second orifices 54 in this example have a different cross-sectional dimension taken perpendicular to the direction of flow to the second orifices 54. The relevant cross-sectional dimension of the second orifices 54 is perpendicular to the line 54a.

Providing different cross-sectional dimensions for the first orifices 52 and the second orifices 54 provides different flow properties through them. By selecting appropriate cross-sectional dimensions, a first mist and second mist, and a selected fire suppression nozzle discharge can be achieved. The diameter influences among other things, the size of the droplet created through effervescent atomization. Further, the diameter and number of orifices influence among other things, the flow split between the first orifice array and the second orifice array.

The use of effervescent atomization to create the mist permits use of larger orifice sizes in many fire suppression applications. Example orifice dimensions include a diameter between about 1.0 and 3 millimeters. In various applications, the diameters of the first orifices 52 and of the second orifices 54 are in the range of 1 mm to less than 2 mm, and 2 mm to 3 mm. One example includes a diameter of about 1.7 millimeters.

Use of larger orifice sizes can eliminate any requirement for a filter in many applications. In some systems that have smaller sized orifices, a filter is typically utilized so that debris does not clog the nozzle. Thus a filter may be avoided in many applications of this invention which simplifies the nozzle and system design.

The invention further includes a bubbler 60 for introducing gas bubbles 62 into the nozzle body 50. The example bubbler 60 includes a plurality of openings 64 through which gas (e.g., air) flows and enters into fluid within the nozzle body 50. The bubbler 60 introduces the gas bubbles 62 to establish a bubbly mixture 66 within the nozzle body 50. The mixture of gas bubbles 62 and fluid (e.g., water) provides a bubbly or frothy mixture that is received in orifices 52 and 54.

It is known that a two-phase flow of a fluid such as a gas and liquid mixture can be categorized depending upon the content of the mixture. One way of categorizing mixtures is described in O. Baker, 1954, “Designing for Simultaneous Flow of Oil and Gas,” Oil and Gas Journal, Vol. 53, pp. 185-195. That document includes a so-called Baker chart that describes when a mixture at equilibrium is in the bubbly or frothy region. Although the mixture 66 within the nozzle body 50 may not be at equilibrium, the characterization of a bubbly or frothy mixture as found in the Baker chart is useful as a reference for describing the kind of bubbly or frothy mixture that is desired in this example for achieving a fire suppression discharge from the nozzle 30. A ratio of the liquid mass flow rate to the gas mass flow rate should be within a certain range to obtain a bubbly flow. For example, when viewed relative to the Baker chart, the resulting gas-to-liquid ratio should be less than 0.005 to achieve a bubbly flow. Example gas-to-liquid mass flow rate ratios in the illustrated examples may be in a range from 0.001 to 0.100.

Controlling the cross-sectional dimension or opening size of the first orifices 52 and the second orifices 54 allows for controlling the water flow though each, respectively. The mass flow rate through an orifice can be described by the equation:

m=ρVAC_{d} (Eq. 1)

where m is the mass flow rate, ρ is the density of fluid through an orifice, V is the velocity of fluid through the orifice and AC_{d} is the effective area of the orifice.

The pressure drop across an orifice can be described by the following equation:

ΔP=½ρV² (Eq. 2).

Solving for V in Eq. 2 provides

$$V = \sqrt{\frac{2 Δ p}{ρ}} .$$

Substituting for V in Eq. 1 yields:

m=\sqrt{2ρΔp}AC_{d}

In one example embodiment having a given fluid density and fluid pressure drop, changing the effective area of an orifice (i.e., AC_{d}) changes the mass flow rate. By providing the first orifices 52 with a first cross-sectional dimension and the second orifices 54 with a second, different cross-sectional dimension, it is possible to achieve a different flow rate through the orifices, respectively. The different flow rates provide different fluid discharge flow properties in this example. Based on the equations presented above, it is also possible to change the mass flow rate through an orifice by changing the fluid pressure drop for a given effective area of the orifice.

The spray dispersion from the orifices 52 and 54 in some examples is influenced by selecting either the size of the bubbler 60 or the position of the bubbler 60 within the nozzle body 50, or both. The nozzle body 50 establishes a plenum for receiving and carrying the bubbly mixture 66 including the gas bubbles 62, which are at a higher pressure than the atmospheric pressure outside of the nozzle body 50. The amount of the plenum occupied by the bubbler 60 has an influence on the bubbly characteristic of the mixture 66 within the nozzle body 50, including the gas to liquid ratio of the bubbly mixture received by the first orifices 52 and the second orifices 54. In one example, a ratio of the cross-sectional area of the bubbler 60 (e.g., based on an outside dimension of the bubbler tube) to the cross-sectional area of the plenum within the nozzle body 50 is kept within a range between 0.2 and 0.75. In other words, the bubbler 60 occupies between 20% and 75% of the area within the plenum in the nozzle body 50. This relationship helps to control the velocity of liquid moving through the nozzle body 50, which affects bubble breakup and mixing, which in turn affects the bubbly characteristic of the mixture 66 within the nozzle body 50.

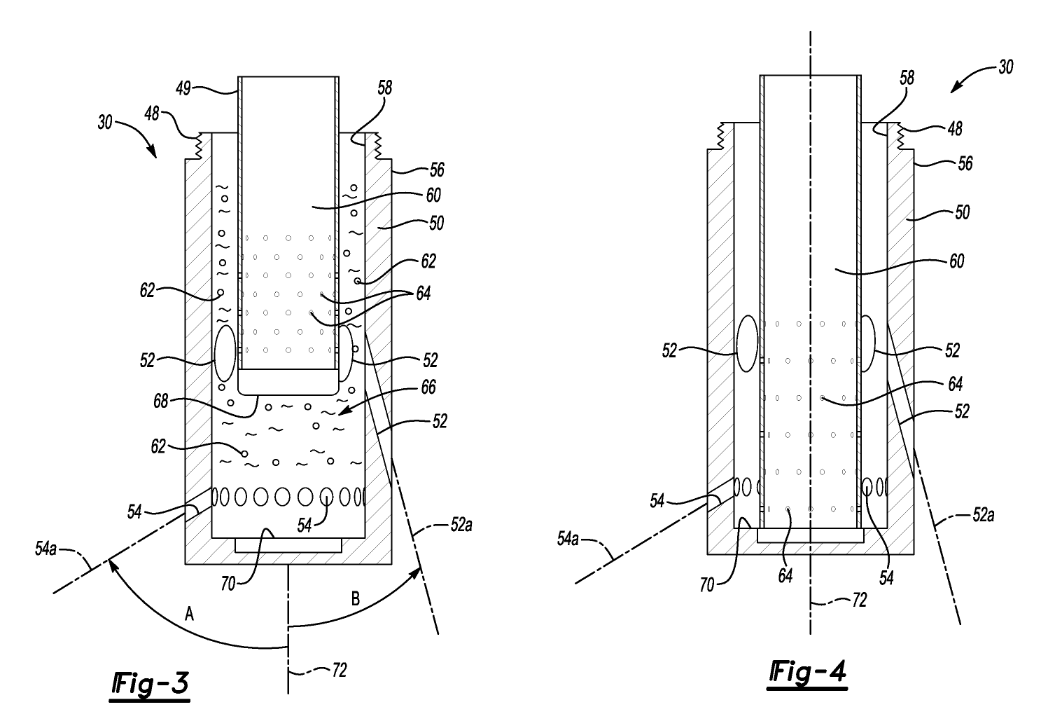

Another way of influencing the spray dispersion from the first and second orifices in some examples is to select a position of the bubbler 60 relative to the nozzle body 50. For example, the relative position of an end 68 of the bubbler 60 and an oppositely facing inside surface 70 within the nozzle body 50 has an effect on the gas-to-liquid ratio. In one embodiment, spacing between the end 68 of the bubbler 60 and the surface 70 within the nozzle body 50 is such that there is an upper mixing region between the outer surface of the bubbler 60 and the inner surface 58 of the nozzle 50 that has an annular cross section as well as a lower mixing region between the end 68 of the bubbler 60 and the surface 70 of the nozzle 50 that has a circular cross section. In another embodiment, the end 68 of the bubbler 60 is received against the surface 70 so that both the upper mixing region and lower mixing region have an annular cross section. The described bubbler positions are illustrated in FIGS. 3 and 4 respectively.

The overall gas to liquid ratio in FIG. 3 and FIG. 4 may be maintained within the same range or same value. However, the gas-to-liquid ratio distribution within the nozzle body 50 of the example of FIG. 3 is different than that of the example of FIG. 4. The nozzle of FIG. 3 can provide a first mist produced by more efficient atomization, while the nozzle of FIG. 4 can provide a first mist with a more concentrated downward pattern. In either example, the bubbly mixture 66 within the nozzle 30 in one region may have a first gas to liquid ratio, and the bubbly mixture 66 in another region may have a second, different, gas to liquid ratio where the difference is enough to control or influence a different flow property through the first orifices 52 and second orifices 54 of the nozzle 30. Depending on the desired fire suppression nozzle discharge, those skilled in the art having the benefit of this description will realize how to configure the orifices 52 and 54 relative to the position of the bubbler 60 to meet the needs of their particular situation.

In one embodiment, the array of first orifices 52 has at least some orifice inlets positioned radially outward from at least a portion of an area of bubbler 60 openings 64. In another embodiment, both the first orifice array and the second orifice array have at least some orifices positioned radially outward from an area of bubbler openings 64. In one embodiment, both the array of first orifices 52 and the array of second orifices 54 have inlets positioned below the bubbler openings 64. The gas-to-liquid mass flow received by orifices 52 and 54, respectively, can control or influence, among other things, the efficiency of the gas bubbles in creating a fine mist.

The relative positions of the entry points of the inlet of the first orifices 52 and second orifices 54 along the nozzle body 50 can be used to control or influence the first flow property and second flow property. In one embodiment, a difference between the first orifices 52 and the second orifices 54 is the axial location of the entry point for the respective orifices along the interior surface 58 of the nozzle body 50. For example, the entry point for the second orifices 54 can be placed much closer to the surface 70 than the entry point for the first orifices 52.

The angle of orientation of the first orifices 52 in the first orifice array and the second orifices 54 in the second orifice array can be used to control or influence the first flow property and second flow property respectively. In one example, the first orifices 52 and the second orifices 54 have a different angle of orientation, angle B and angle A respectively, relative to a central axis 72 of the nozzle body 50. In one embodiment, the second orifices 54 have an oblique angle of orientation A, which is schematically shown between the axis 72 and the second orifice axis 54a. In one example the angle A is approximately 60°. Some examples include the angle A arranged between 0 and 70°. The first orifices 52 have an angle of orientation B between the axis 72 and the first orifice axis 52a different from angle A. In one example, the angle B is approximately 15°. In other examples the angle B may be arranged between 0° and 70°. The direction of the respective angles controls or influences, among other things, the turbulence of the bubbly flow into the orifice, the direction of the spray dispersion from each orifice and the first mist and second mist, the degree to which the first mist and second mist interact, and the resulting flux density in a measured area. In one example, the first mist and second mist graze one another.

In one embodiment, the first orifices 52 direct an effervescent fire suppression nozzle discharge within an area or region more directly beneath the nozzle 30 compared to the effervescent fire suppressing fluid discharge from the second nozzle orifices 54. The different angles of orientation allows for achieving a desired distribution of fire suppressing fluid in the area of coverage surrounding the nozzle 30. According to one example, either of the first mist or second mist may deflect and entrain the other. For example, the first orifices 52 may be at a lesser angle from the axis than the second orifices 54, and the first mist may deflect and entrain the second mist in the direction of the first mist. The interaction of the first mist and second mist helps to provide a more uniform flux density in the area of coverage surrounding the nozzle.

In one embodiment there are a different number of first orifices 52 and second orifices 54. In one example, there are more second orifices 54 than there are first orifices 52.

In one example embodiment, the first mist resulting from the first orifice array having first orifices 52 comprises a first droplet size and initial velocity. The initial velocity here refers to an initial speed and direction of a droplet as it exits an orifice. The second mist resulting from the second orifice array having second orifices 54 comprises a second droplet size and initial velocity. In one example, the droplet sizes from first orifices 52 and second orifices 54 are in a range between 10 and 1,000 micrometers in diameter. In yet other examples, the droplet sizes are in the range of 10 to less than 50 micrometers in diameter, or in the range of 50 to less than 300 micrometers in diameter, or in the range of 300 to less than 500 micrometers in diameter, or in the range of 500 to less than 1000 micrometers in diameter. In some examples, the first and second droplet sizes are different while in others they are the same. The representative droplet sizes can be based upon the Sauter mean diameter method. In some examples, the respective initial velocities comprise at least a different direction. Achieving different droplet sizes, initial velocities or both from the first orifices 52 and the second orifices 54, respectively, allows for controlling the resulting fire suppression discharge provided by the nozzle 30.

The combination of droplet size and velocity creates the spray momentum, and are factors enabling water mist resulting from effervescent atomization to, among other things, both disperse and also penetrate a fire to provide effective evaporative cooling, inerting, radiation blocking, and wetting for fire suppression application in an area of coverage surrounding the nozzle

In examples having orifices at different angles, the droplets from the first orifices 52 may have a different initial velocity than the droplets from the second orifices 54. The different initial velocities in such an example result in, among other things, wide spray coverage of an area in which fire suppression is desired.

One embodiment has a ratio of an aeration area to a discharge area that is within a selected range for controlling the gas-to-liquid ratio for a given pressure drop. The aeration area is an area that the bubbler openings 64 collectively occupy. The discharge area is that area occupied collectively by the nozzle orifices 52 and 54. The discharge area is dependent on the cross-sectional dimension of the orifices that is perpendicular to a central axis of the orifice as discussed above. The ratio of the aeration area to the discharge area is between about 0.25 and 1.

In one embodiment, a selected ratio of the size of the bubbler openings 64 to a size of the orifices 52 or 54, is within a selected range. As described above, each of the nozzle orifices, the first orifices and the second orifices, has a cross-sectional dimension that defines a size of the orifice. The bubbler openings 64 also have a cross-sectional dimension establishing an opening size. The ratio of the opening size to the orifice size is less than about 1.0. In some examples, the ratio of the bubbler opening 64 size to the first orifice 52 size and the ratio of the bubbler opening 64 size to the second orifice 54 size are each between about 0.05 and less than about 1.0, or each between about 0.05 and 0.20, or each between about 0.20 and less than about 1.0, or between about 0.20 and 0.95. The ratio of the opening size to the orifice size allows for controlling or influencing the droplet size for achieving a desired fire suppression discharge from the example nozzles 30.

In one embodiment, the relationship between a cross-sectional dimension area of the plenum within the nozzle body 50 and the area collectively occupied by the first and second nozzle orifices 52 and 54 is within a selected range. In one example, the plenum has an area that is at least twice the area collectively occupied by the first nozzle orifices 52 and second nozzle orifices 54 combined.

One aspect of using effervescent atomization is that it allows for operating at a significantly lower pressure compared to other atomizing or misting sprinkler-based fire suppression systems. One example operates using a gauge pressure between 3 and 11 bar. One example operates at a gauge pressure on the order of 2.8 bar. In one example, providing the gas (e.g., air) from the bubbler 60 at a pressure that may be as low as 1 psig above the pressure of the liquid in the system achieves effervescent atomization that yields a fire suppression nozzle discharge. This reduces pressure requirements, which provides a more cost-effective system. Material requirements are relaxed as there is no need to design system components to withstand relatively high pressures. Additionally, this approach requires less energy to operate the system compared to many higher pressure systems.

The pressures that can be used with example embodiments of this invention are significantly less than other single fluid atomizing systems that rely on operating gauge pressures between about 12 and 34.5 bar and about 34.5 and 200 bar. Many such intermediate and high pressure systems rely upon high pressure to shear the water or other liquid that is sprayed from a nozzle head to provide an effective fire suppression discharge. The disclosed embodiments, on the other hand, are capable of providing the an effective fire suppression discharge from the nozzle at much lower pressures than typical single fluid fire suppression water mist systems. As the bubbles 62 expand when they exit the orifices 52 and 54, they shatter the liquid (e.g., water) of the fire suppressing fluid into droplets of a size that establishes a desired first and second mist that form selected fire suppression nozzle discharge for suppressing or extinguishing a fire in an area of coverage surrounding the nozzle 30.

The example nozzle bodies 50 include a connection feature 48 for connecting the nozzle 30 to the liquid supply line 24. In the example of FIG. 3, the connection feature 48 comprises a threaded end on the nozzle body 50. The example bubbler 60 also includes a connection feature 49 for connecting the bubbler 60 to the gas supply line 28 of the fire suppression system 20.

As described below, the embodiments shown in the Figures illustrate example combinations of features yielding a desired suppression nozzle discharge and are not intended to restrict the possible combinations of those features for realizing other fire suppression nozzle discharges.

In the example of FIG. 3, the first orifices 52 have a cross sectional dimension that is different than the cross sectional dimension of the second orifices 54. In this case, the cross sectional dimension of the first orifices 52 is less than that of the second orifices 54. The first orifices 52 have an inlet along the interior surface 58 at a different axial position compared to the inlet of the second orifices 54. That arrangement provides a difference between the location of the entry for the first orifices 52 relative to the position of the bubbler 60 compared to that of the second orifices 54. In this embodiment, each first orifice 52 has an inlet on the inner surface 58 of the nozzle body 50 in a position radially outward from an area of the bubbler 60 having the bubbler openings 64 and where the mixing area has a cross section that is annular. The second orifices 54 have an inlet on the interior surface 58 of the nozzle body at an axial position below the bubbler 60 and in a region where the mixing area has a cross section that is circular. The first orifices 52 have an outlet on the exterior surface 56 above the location of the second orifices 52 outlet. The first mist and second mist graze one another. In FIG. 3, the first angle B is less than the second angle A. In this embodiment, the first mist deflects and entrains at least a portion of the second mist in the direction of the first mist. In this example, the interaction of the first mist and the second mist influences a more uniform distribution of spray below the nozzle. The first orifices 52 are evenly spaced circumferentially around the nozzle. Each first orifice 52 is at an angle B that is about 15 degrees. The second orifices 54 are evenly spaced circumferentially around the nozzle. Each second orifice 54 is at an angle A that is about 60 degrees. The first orifices 52 and the second orifices 54 are circumferentially offset, such that they are not in line with one another along the length of the nozzle. In another embodiment, the first orifices 52 and second orifices 54 may have the same cross sectional dimension.

In the example of FIG. 4, the first orifices 52 and second orifices 54 have cross sectional dimensions and entry locations along the interior surface similar to the orifices of FIG. 3. The first angle B is less than the second angle A. Each first orifice 52 of the first orifice array is located axially above each second orifice 54 of the second orifice array. The bubbler 60 extends the length of the nozzle. The first mist and second mist emerge and graze one another. The first mist deflects and entrains at least a portion of the second mist in the direction of the first mist. This influences a more uniform distribution of spray below the nozzle. In one embodiment, at least some first orifices 52 of the first orifice array are circumferentially offset from at least some second 54 orifices of the second orifice array.

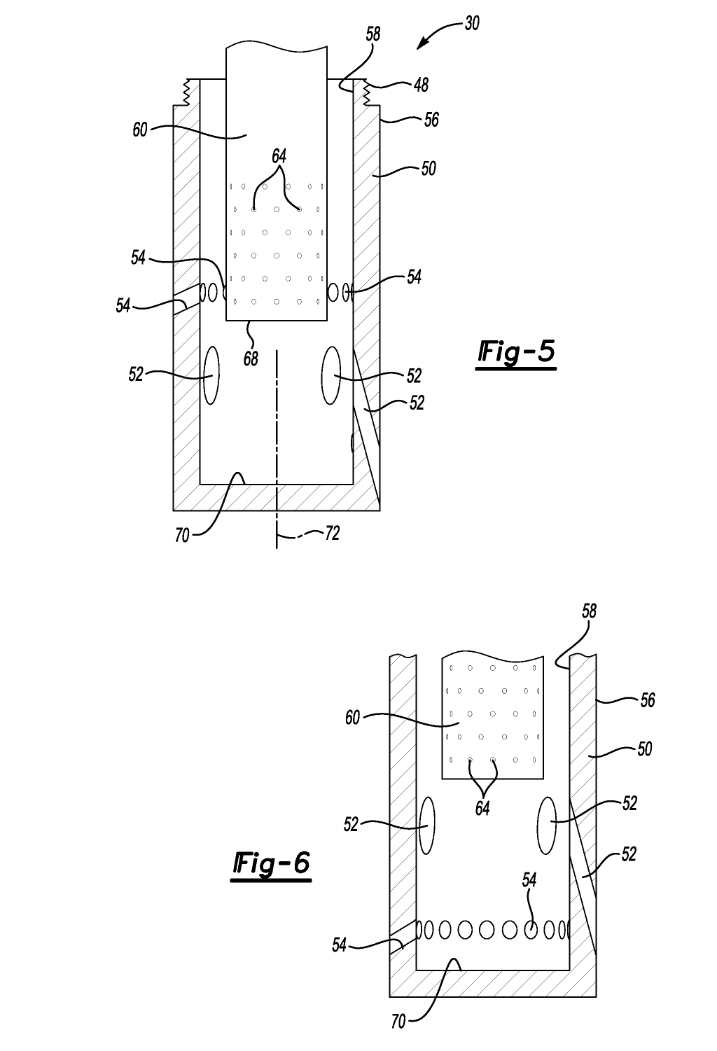

In the example of FIG. 5, the second orifices 54 have an inlet on the interior surface 58 of the nozzle body 50 in the vicinity of at least some of the bubbler openings 64, and the first orifices 52 have an inlet slightly below the second orifices 54.

The first angle B is less than the second angle A. In this example, the first orifices 52 are at an angle B of about 15 degrees, and the second orifices 54 are at an angle A of about 60 degrees. The first orifices 52 exit lower on the outer surface 56 of the nozzle body 50 and are projected more downward than the second orifices 54 which are projected more outward. In this example, the first mist and second mist do not significantly interact with one another.

FIG. 6 illustrates another configuration of an example nozzle 30. In this example, the inlets to the first orifices 52 are above the inlets to the second orifices 54 along the interior surface 58 of the nozzle body 50. The outlets on the exterior surface 56 of the nozzle for the first orifices 52 and the second orifices 54 are at approximately the same axial position along the nozzle body 50. In FIG. 6, the first mist and second mist graze one another. In this example, the first mist and second mist deflect and entrain at least a portion of the other. This influences a more uniform distribution of spray below the nozzle.

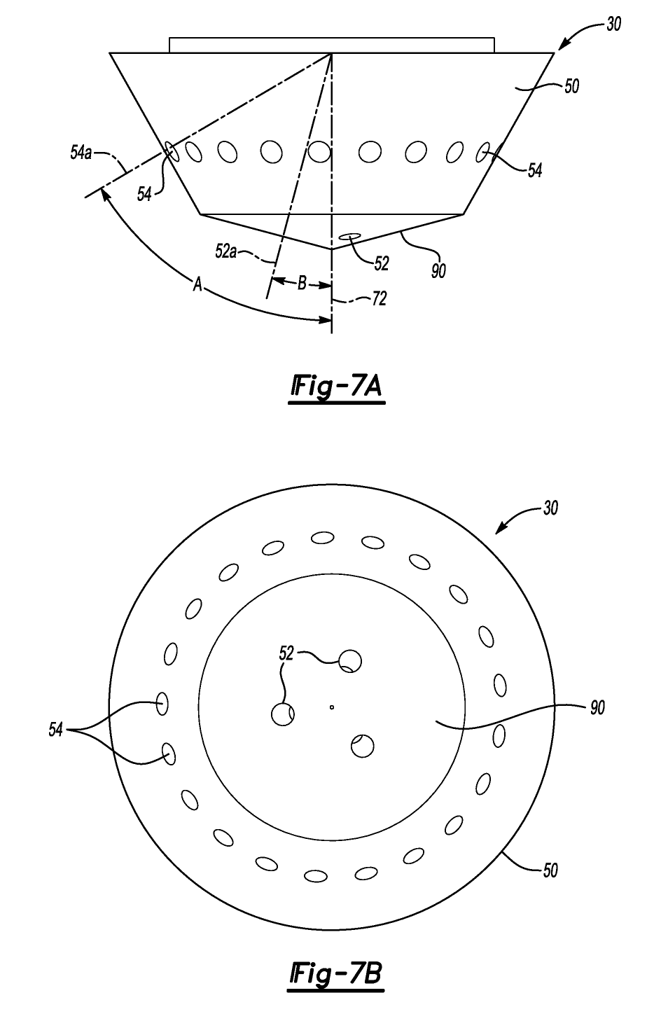

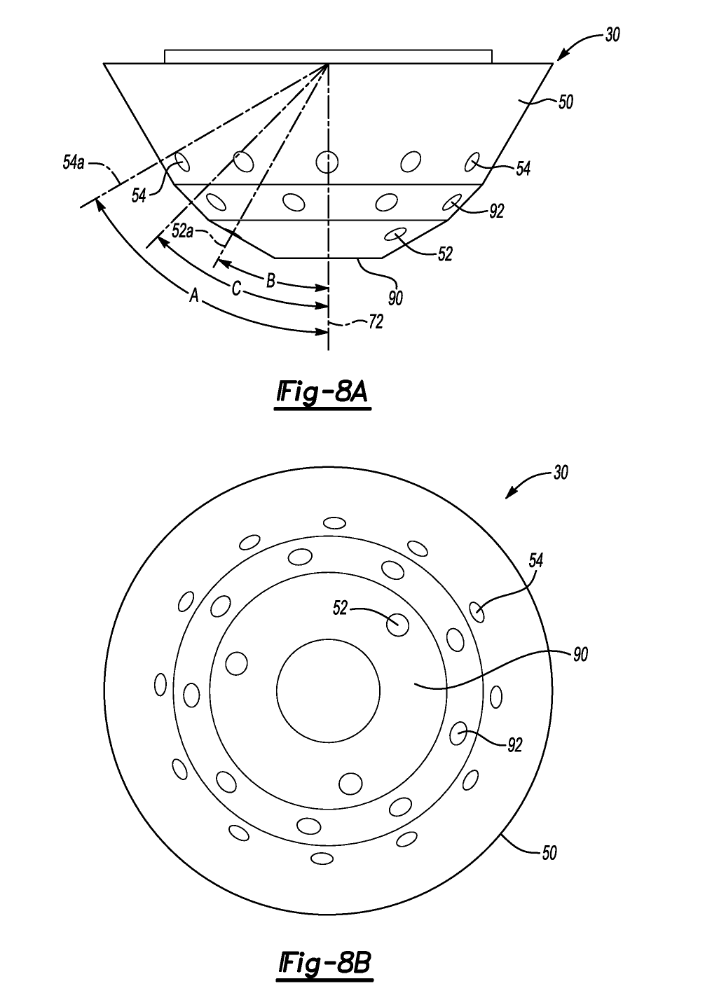

FIGS. 7A and 7B show another arrangement of orifices 52 and 54 on an example fire suppression nozzle 30. In this example, the first orifices 52 are located on an end portion 90 of the nozzle body 50. The first orifices 52 are oriented at the angle B to provide at least some of the fire suppression discharge at locations directly beneath the nozzle 30. The second orifices 54 are oriented at a larger oblique angle A like those in the example of FIG. 3.

8A and 8B illustrate another example nozzle configuration. This example also includes first orifices 52 and second orifices 54 with relative angles of orientation similar to those in the example of FIG. 3. This example includes third orifices 92 at a third oblique angle relative to the axis 72 of the nozzle body 50. In this example, the third oblique angle C is in a range from 30° to 45°. The angle A is in a range from 45° to 60° and the angle B is in a range from 0° to 30°.

The embodiments and different illustrated nozzles provided in the Figures allow for creating and directing a first mist and a second mist in a selected fire suppression discharge from the nozzle to, among other things, provide a desired ability to penetrate a fire and disperse mist having desired suppression characteristics in a coverage area surrounding a nozzle. The disclosed examples include various features and relationships that are conducive to establishing a fire suppression discharge resulting from effervescent atomization. Any one of the discussed features or relationships may be used in combination with any others of them. For example, various combinations of the position or size of the bubbler 60 and the size of the plenum can be implemented to control a desired spray dispersion from the first orifices 52 and the second orifices 54, respectively. Alternatively, various combinations of orifice size, orifice angle, orifice entry and orifice outlet, and nozzle location (e.g., height above the area to be protected) can be implemented to control water flux distribution. Some of the illustrated examples do not include all of the features but only a selected one or a selected combination of less than all of them. Other disclosed examples include a combination of more features compared to another disclosed example. Each of the disclosed examples includes first orifices 52 and second orifices 54 having different flow properties that yield a desired effervescent atomization for realizing a first mist and a second mist and a selected fire suppression discharge from the nozzle.

The preceding description is exemplary rather than limiting in nature. Variations and modifications to the disclosed examples may become apparent to those skilled in the art that do not necessarily depart from the essence of this invention. The scope of legal protection given to this invention can be determined by studying the following claims.

1. A fire suppression system, comprising:
a nozzle body configured to carry a fire suppressing fluid to be discharged from a first orifice array and a second orifice array; and
a bubbler through which gas bubbles can be introduced into the fire suppressing fluid to establish a bubbly mixture in the nozzle;
the first orifice array having at least one first orifice, each first orifice has a first flow property and is configured to receive the bubbly mixture and through effervescent atomization yield a first fire suppression mist from the first orifice array;
the second orifice array having at least one second orifice, each second orifice has a second, different flow property and is configured to receive the bubbly mixture and through effervescent atomization yield a second fire suppression mist from the second orifice array;
the first fire suppression mist and the second fire suppression mist are configured to provide a selected fire suppression nozzle discharge.

2. The fire suppression system of claim 1, wherein
the selected fire suppression nozzle discharge includes distribution of fire suppressing fluid in an area below the nozzle body;
the first orifice array influences the distribution of fire suppression fluid in a first portion of an area below the nozzle body; and
the second orifice array influences the distribution of fire suppression fluid in a second portion of an area below a nozzle body.

3. (canceled)

4. The fire suppression system of claim 1, wherein the selected fire suppression nozzle discharge includes distribution of suppression fluid in a generally circular area of approximately 3.5 meters in radius at a distance 5 meters below the nozzle.

5. The fire suppression system of claim 4, wherein the selected fire suppression nozzle discharge comprises distribution of suppression fluid that is generally uniform in the circular area with an average water flux measured in any 0.25 square meter portion of the circular area that is greater than 0.05 liters per minute per square meter.

6. The fire suppression system of claim 4, wherein the selected fire suppression nozzle discharge comprises distribution of suppression fluid with an average water flux measured inside a circle about 1 meter in radius located about 5 meters directly below the nozzle body that is at least one liter per minute per square meter.

7. The fire suppression system of claim 1, wherein
the first orifices have a first cross-sectional dimension; and
the second orifices have a second, different cross-sectional dimension.

8. (canceled)

9. The fire suppression system of claim 1, wherein the first orifices are aligned at a first oblique angle relative to an axis of the nozzle and the second orifices are aligned at a second, different oblique angle relative to the axis of the nozzle such that one of the first or second orifices discharge mist from the nozzle in a more radially outward direction than the other of the second or first nozzle orifices.

10. The fire suppression system of claim 1, wherein
the first flow property results in a first spray dispersion of the fire suppressing fluid flowing from the first orifices;
the second different flow property results in a second, different spray dispersion of the fire suppressing fluid flowing from the second orifices.

11. The fire suppression system of claim 10, wherein
the bubbler is within the nozzle body in a position relative to the axial end of the nozzle body; and
gas from the bubbler mixes with liquid in the nozzle body in a manner that provides the first and second spray dispersions, respectively.

12. The fire suppression system of claim 1, wherein
the first orifices each have an entry defined on an inner surface of the nozzle body at a first position relative to the position of the bubbler, the first position configured to receive the bubbly mixture having a first gas to liquid ratio; and
the second orifices each have an entry defined on the inner surface of the nozzle body at a second, different position relative to the position of the bubbler, the second position configured to receive the bubbly mixture having a second different gas to liquid ratio.

13. The fire suppression system of claim 1, wherein
the first orifices each have an entry defined on an inner surface of the nozzle body at a first distance from an axial end of the nozzle body; and
the second orifices each have an entry defined on the inner surface of the nozzle body at a second, different distance from the axial end of the nozzle body.

14. The fire suppression system of claim 1, wherein
the first flow property results in a first mist having a first droplet size at a first initial velocity;
the second flow property results in a second mist having a second droplet size at a second initial velocity; and
at least one of the first and second droplet sizes or the first and second initial velocities are different from each other.

15. (canceled)

16. The fire suppression system of claim 1, wherein
the first and second orifices each have a cross-sectional area that is generally perpendicular to a direction of flow through the orifices;
the areas of the nozzle orifices collectively occupy a discharge area;
the bubbler comprises a plurality of bubbler openings that collectively occupy an aeration area; and
a ratio of the aeration area to the discharge area is between about 0.25 and 1.

17. The fire suppression system of claim 1, wherein
each of the nozzle orifices has an orifice size;
the bubbler comprises a plurality of openings each having an opening size; and
a ratio of the opening size to the orifice size is less than about 1.0.

18. (canceled)

19. The fire suppression system of claim 1, wherein
the nozzle body has a plenum configured to contain a bubbly mixture of gas bubbles and liquid; and
the plenum has an area that is at least twice an area collectively occupied by the first and second nozzle orifices.

20. The fire suppression system of claim 1, wherein
the nozzle body has a plenum configured to contain a bubbly mixture of gas bubbles and liquid;
the bubbler comprises a tube having a plurality of openings at least partially within the plenum; and
the tube occupies between 20 and 75 percent of an area within the plenum.

21. The fire suppression system of claim 1, comprising a gas flow rate between 50 and 1000 standard liters per minute and a liquid flow rate between 19 and 57 liters per minute.

22. (canceled)

23. The fire suppression system of claim 1, wherein the first orifice array includes a plurality of first orifices and second orifice array includes a plurality of second orifices.

24. The fire suppression system of claim 23, wherein at least some first orifices of the first orifice array are circumferentially offset from at least some second orifices of the second orifice array.

25. The fire suppression system of claim 1, wherein the first mist and second mist graze one another.

26. The fire suppression system of claim 25, wherein
the outlet of each first orifice in the first orifice array is located at a different axial location relative to the axis of the nozzle than the outlet of each second orifice in the second orifice array.

27. The fire suppression system of claim 1, wherein
each first orifice in the first orifice array is aligned at a first angle relative to an axis of the nozzle; and
each second orifice in the second orifice array is aligned at a second different angle relative to an axis of the nozzle.

28. The fire suppression system of claim 27, wherein
the first orifices each have an entry defined on an inner surface of the nozzle body at a first axial position relative to the axis of the nozzle, the first axial position configured to receive the bubbly mixture in a region having a first gas to liquid ratio; and
the second orifices each have an entry defined on the inner surface of the nozzle body at a second, different axial position relative to the axis of the nozzle, the second axial position configured to receive the bubbly mixture in a region having a second different gas to liquid ratio.
